(19) United States
(12) Patent Application Publication
(10) Pub. No.: US 2026/0367555 A1
(43) Pub. Date: Nov. 19, 2026

(54) HEATING DEVICE AND FIXING UNIT

(71) Applicant: CANON KABUSHIKI KAISHA, Tokyo (JP)

(72) Inventors: TOMOKI MATSUDA, Shizuoka (JP); TAKAAKI TSURUYA, Shizuoka (JP)

(21) Appl. No.: 19/674,255

(22) Filed: May 12, 2026

(30) Foreign Application Priority Data
May 16, 2025 (JP) 2025-082531

(51) Int. Cl. G03G 15/20

(52) U.S. Cl. CPC G03G 15/2057; G03G 15/2064; G03G 2215/2035

(57) ABSTRACT

A heating device includes a fixing member, and a temperature sensor configured to detect a temperature of the fixing member. The fixing member includes a base layer, and a conductive layer configured to generate heat due to an induced electromotive force when an alternating magnetic field is generated. The conductive layer includes a plurality of conductors each having a ring shape and being electrically separated from each other in a longitudinal direction of the fixing member. An inner circumferential surface of the base layer has an uneven shape in which a plurality of concave portions and a plurality of convex portions are alternately arranged multiple times in the longitudinal direction. At least one convex portion of the plurality of convex portions is arranged to contact the temperature sensor and is positioned at the same location in the longitudinal direction as at least one conductor of the plurality of conductors.

### BACKGROUND

### Field of the Technology

The present disclosure relates to a heating device that heats a toner image borne on a recording material, and a fixing unit including the same.

### Description of the Related Art

Japanese Patent Application Laid-Open Publication No. 2021-117363 proposes an electromagnetic induction heating type fixing unit. This fixing unit includes a fixing film with a plurality of heat-generating layers divided in a rotation axial direction, a magnetic core provided in an internal space of the fixing film, a spiral excitation coil wound around the magnetic core, a film guide, and a pressure roller that forms a nip portion together with the film guide. The fixing unit is also provided with a thermistor that detects a temperature of the fixing film, and a control unit of a fixing unit controls a current flowing through the excitation coil based on a detection result of the thermistor.

However, the thermistor described in Japanese Patent Application Laid-Open Publication No. 2021-117363 has a problem with responsiveness to changes in the temperature of the heat-generating layer of the fixing film. For example, in a case where a distance between the heat-generating layer and the thermistor is large, it may cause a decrease in the responsiveness of the thermistor.

One of the problems that the embodiments disclosed in the present specification and drawings attempt to solve is to provide technology that can improve responsiveness of a temperature sensor to changes in a temperature of a fixing member. However, the problems that the embodiments disclosed in the present specification and drawings attempt to solve are not limited to the above problem. Problems that correspond to effects of configurations shown in the embodiments to be described below can also be positioned as other problems.

### SUMMARY

According to one aspect of the present disclosure, a heating device configured to heat a toner image borne on a recording material includes a fixing member configured to be rotatable and formed in a cylindrical shape, and a temperature sensor configured to detect a temperature of the fixing member. The fixing member includes a base layer, and a conductive layer configured to generate heat due to an induced electromotive force when an alternating magnetic field is generated. The conductive layer includes a plurality of conductors each having a ring shape and being electrically separated from each other in a longitudinal direction of the fixing member. An inner circumferential surface of the base layer has an uneven shape in which a plurality of concave portions and a plurality of convex portions are alternately arranged multiple times in the longitudinal direction. At least one convex portion of the plurality of convex portions is arranged to contact the temperature sensor and is positioned at the same location in the longitudinal direction as at least one conductor of the plurality of conductors.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view showing a printer according to Embodiment 1.

FIG. 2A is a cross-sectional view showing a fixing unit, and FIG. 2B is a cross-sectional view showing a temperature sensor.

FIG. 3A is a cross-sectional view showing a region of a fixing film where a conductive layer is present, FIG. 3B is a cross-sectional view showing a region of the fixing film where a conductive layer is not present, and FIG. 3C is a cross-sectional view showing a cross-section parallel to a longitudinal direction of the fixing film.

FIG. 4 is a perspective view showing the fixing film, a magnetic core, and an excitation coil.

FIG. 5A is a cross-sectional view showing a magnetic field and a current flowing through a conductive layer, and FIG. 5B is a perspective view showing a magnetic field and a current flowing through the conductive layer.

FIG. 6 is a cross-sectional view showing the fixing film at a position where the temperature sensor abuts.

FIG. 7 is a cross-sectional view showing a fixing film as a comparative example.

FIG. 8 is a cross-sectional view showing a fixing film according to Modification Example 1 at a position where a temperature sensor abuts.

FIG. 9 is a cross-sectional view showing a fixing film according to Modification Example 2 at a position where a temperature sensor abuts.

FIG. 10A is a cross-sectional view showing a fixing unit according to Embodiment 2, and FIG. 10B is a perspective view showing a heating device.

### DESCRIPTION OF THE EMBODIMENTS

Embodiments of the present disclosure will be described below with reference to the drawings. In the present disclosure, the term “image forming apparatus” is not limited to a single-function printer equipped with only a printing function, but also broadly includes apparatuses that form images on a recording material, such as copiers equipped with a copying function, multifunction devices equipped with a plurality of functions, and large commercial printers.

In the present disclosure, the term “fixing unit” broadly includes devices (image heating devices) that heat an image (toner image), which is formed on a recording material by an electrophotographic process or the like, and fix the image onto the recording material. The fixing unit may be disposed to reheat the image already fixed (primarily fixed) onto the recording material to impart a gloss.

### Embodiment 1

### Image Forming Apparatus

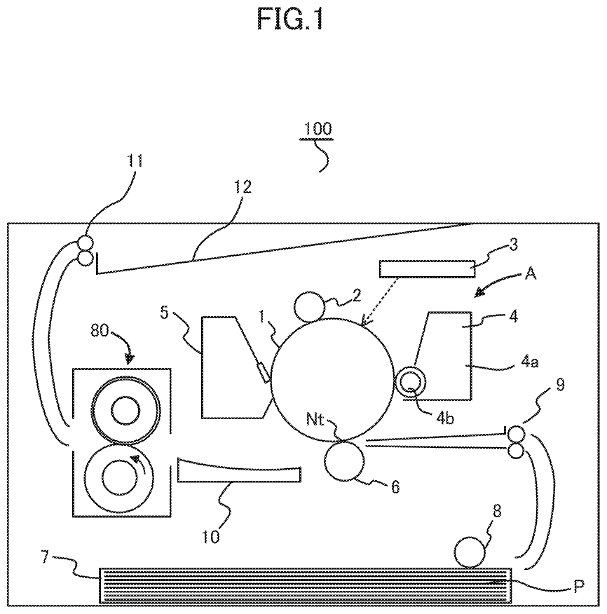

An overall configuration of an image forming apparatus according to Embodiment 1 of the present disclosure will be described with reference to FIG. 1. FIG. 1 is a cross-sectional view showing a schematic configuration of a laser beam printer (hereinafter referred to as a printer 100) as an example of the image forming apparatus. Based on image information received from an external device such as a personal computer, the printer 100 executes an image forming operation of forming an image on a recording material P. Various sheet materials of different sizes and materials can be used as the recording material P (recording medium), the sheet materials including paper such as plain paper and cardboard, surface-treated sheet materials such as coated paper, specially shaped sheet materials such as envelopes and index paper, a plastic film, cloth, and the like.

The printer 100 includes an image forming unit 70 that forms an image (toner image) on the recording material P by an electrophotographic process, and a fixing unit 80 that fixes the image onto the recording material P. The image forming unit 70 includes a photosensitive drum 1 serving as an image bearing member, a charging roller 2 serving as a charging unit, a laser scanner 3 serving as an exposure unit, and a developing device 4 serving as a developing unit. The image forming unit 70 also includes a transfer roller 6 serving as a transfer unit and a cleaner 5 serving as a cleaning unit. The photosensitive drum 1 is a cylindrically molded photosensitive member. The developing device 4 includes a container 4a that contains a toner serving as a developer, and a developing roller 4b that carries the toner and supplies the toner to the photosensitive drum 1.

During the image forming operation, the photosensitive drum 1 is rotationally driven, and the charging roller 2 uniformly charges a surface of the photosensitive drum 1. The laser scanner 3 receives a digital image signal generated based on image information by the image processing unit of the printer 100, thereby irradiating the photosensitive drum 1 with laser light to expose the photosensitive drum 1 to light and writing an electrostatic latent image corresponding to the image information on the surface of the photosensitive drum 1. The developing device 4 supplies a toner to the photosensitive drum 1 and develops the electrostatic latent image into a toner image.

In parallel with creation of the toner image, the recording material P is conveyed. A cassette 7 is accommodated in a lower part of the printer 100 to be drawable. The recording material P is accommodated in the cassette 7 in a stacked state. The recording materials P accommodated in the cassette 7 are fed one by one by a feed roller 8 serving as a feeding unit, and are conveyed to a transfer nip portion Nt by a conveyance roller pair 9.

The transfer roller 6 transfers a toner image from the photosensitive drum 1 to the recording material P at the transfer nip portion Nt between the photosensitive drum 1 and the transfer roller 6. Foreign substances such as a transfer residual toner that remains on the photosensitive drum 1 without being transferred to the recording material P are removed by the cleaner 5.

After passing through the transfer nip portion Nt, the recording material P is transmitted to the fixing unit 80. While conveying the recording material P, the fixing unit 80 applies heat and pressure to the image (toner image) on the recording material P and fixes the image to the recording material P. Details of the fixing unit 80 will be described later. After passing through the fixing unit 80, the recording material P is discharged onto a sheet discharge tray 12 by a discharge roller pair 11.

In the present embodiment, a direct transfer image forming unit has been described, but an intermediate transfer image forming unit may also be used, in which a toner image is primarily transferred from an image bearing member to an intermediate transfer body such as an intermediate transfer belt, and then the toner image is secondarily transferred from the intermediate transfer body to a recording material. The image forming unit may also be one that creates a color image using a plurality of colors of toners.

### Fixing Unit

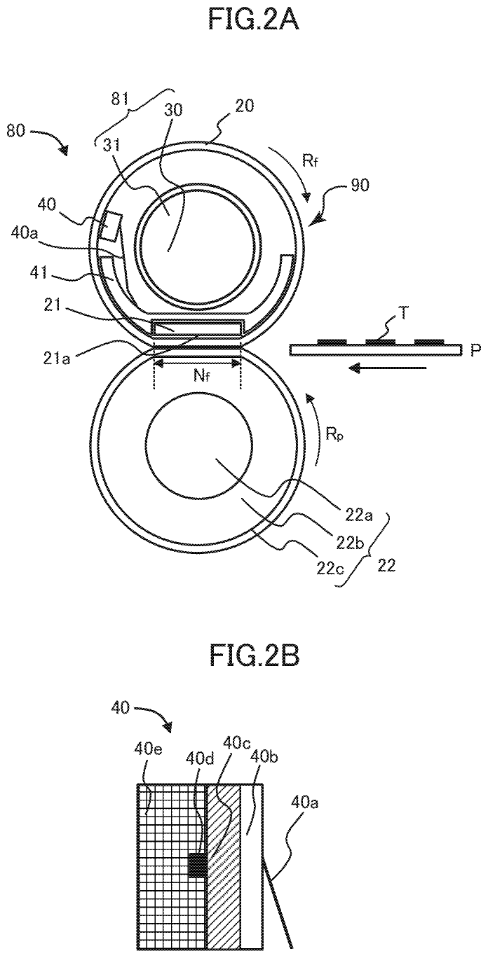

Next, the fixing unit 80 will be described. In the present embodiment, the fixing unit 80 is an electromagnetic induction heating type fixing unit. FIG. 2A is a cross-sectional view showing the fixing unit 80. As shown in FIG. 2A, the fixing unit 80 includes a heating device 90 and a pressing roller 22 serving as a pressing member. The heating device 90 includes a fixing film 20, a nip portion forming member 21, and a film guide 41 that slides against an inner circumferential surface of the fixing film 20 to hold the fixing film 20.

The fixing unit 80 also includes a magnetic field generation unit 81 that generates an alternating magnetic field in a longitudinal direction LD (generatrix direction) of the fixing film 20, and a temperature sensor 40. The temperature sensor 40 is disposed to contact the inner circumferential surface of the fixing film 20 and detects a temperature of the fixing film 20. In the present embodiment, the temperature sensor 40 is disposed to contact the inner circumferential surface of the fixing film 20, but this is not limiting. For example, the temperature sensor 40 may be configured to detect the temperature of the fixing film 20 without contacting the inner circumferential surface of the fixing film 20.

The fixing film 20 serving as both a fixing member and a rotary member is made of a flexible cylindrical (endless) film. The fixing film 20 is an example of a fixing member that heats the image on the recording material P and is rotatable. The nip portion forming member 21 is made of heat-resistant resin or the like and is inserted into an internal space of the fixing film 20. The nip portion forming member 21 has a flat surface 21a that contacts and slides against the inner circumferential surface (inner surface) of the fixing film 20. The pressing roller 22 abuts against the nip portion forming member 21 to sandwich the fixing film 20 therebetween and forms a nip portion Nf (fixing nip) between itself and the flat surface 21a of the nip portion forming member 21.

The pressing roller 22 includes a core bar 22a, an elastic layer 22b formed on an outer surface of the core bar 22a, and a release layer 22c formed on an outer surface of the elastic layer 22b. In the present embodiment, an outer diameter of the pressing roller 22 is 30 mm.

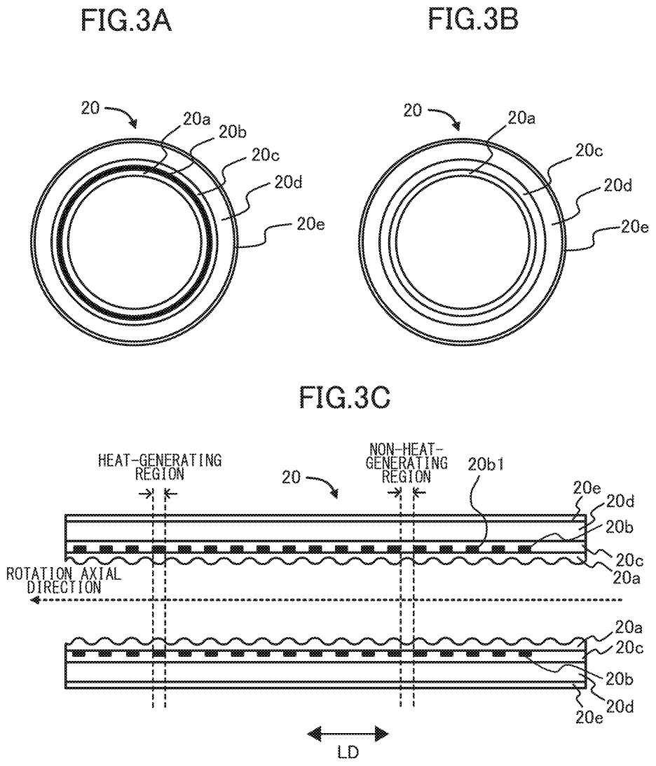

The magnetic field generation unit 81 includes a magnetic core 30 serving as a magnetic body and an excitation coil 31 serving as a coil. An alternating current flows through the excitation coil 31 to generate an alternating magnetic field, which induces a current in a circumferential direction in a conductive layer 20b (see FIG. 3B) of the fixing film 20.

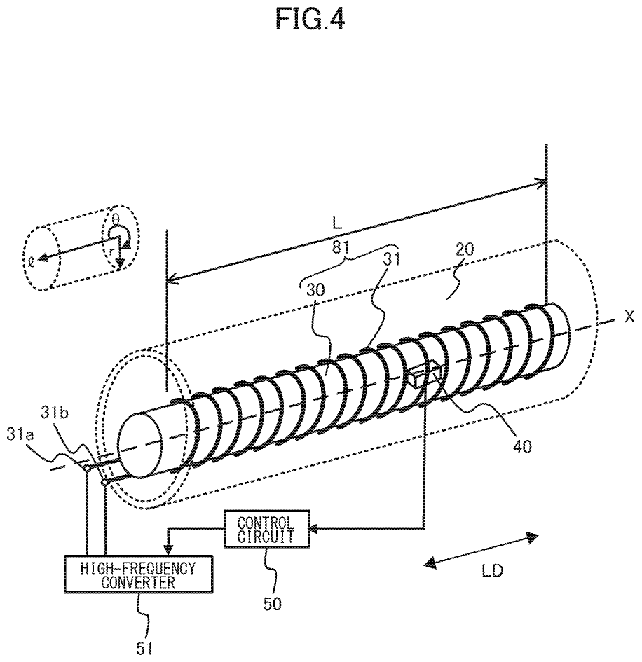

The fixing film 20, the magnetic core 30, the pressing roller 22, the nip portion forming member 21, and the film guide 41 are all members that are elongated in the longitudinal direction LD (see FIG. 4) of the fixing film 20. In other words, the longitudinal direction LD can also be referred to as the generatrix direction of the fixing film 20. Lengths of the fixing film 20, the magnetic core 30, the pressing roller 22, the nip portion forming member 21, and the film guide 41 in the longitudinal direction LD are longer than a maximum width of the recording material P that can be conveyed to the fixing unit 80.

The film guide 41 is made of heat-resistant resin or the like and is inserted inside the fixing film 20. When viewed in a rotation axial direction of the pressing roller 22, the film guide 41 is disposed symmetrically in a sheet conveyance direction, centered on the nip portion Nf. The film guide 41 rubs against the inner circumferential surface of the fixing film 20 when the fixing film 20 rotates, thereby stabilizing a rotational trajectory of the fixing film 20.

The fixing unit 80 includes a frame (not shown) that supports both longitudinal ends of the nip portion forming member 21. The frame rotatably supports a shaft of the core metal 22a of the pressing roller 22 via bearing members (not shown). The pressing roller 22 is pressed toward the nip portion forming member 21 by an urging member (not shown), such as a pressure spring. In the present embodiment, the urging member applies a pressing force of a total pressure of approximately 196 N to 392 N (approximately 20 kgf to 40 kgf) to the bearing members provided at both ends of the pressing roller 22. Thereby, the elastic layer 22b of the pressing roller 22 collapses and elastically deforms, and the nip portion Nf with a predetermined width is formed by the surface of the fixing film 20 and the surface of the pressing roller 22.

In the present embodiment, the pressing roller 22 is biased toward the nip portion forming member 21, but this is not limiting. For example, the nip portion forming member 21 may be biased toward the pressing roller 22 by the urging member.

FIG. 2B is a cross-sectional view showing the temperature sensor 40 according to the present embodiment. As shown in FIG. 2B, the temperature sensor 40 includes a plate spring 40a, a sponge 40b, a metal heat collecting plate 40c, and a thermistor (temperature detection element) 40d. A first end of the plate spring 40a is fixed to the film guide 41, and a second end of the plate spring 40a is fixed to the sponge 40b. The heat collecting plate 40c is provided on the sponge 40b, and the thermistor 40d is provided on the heat collecting plate 40c.

The metal heat collecting plate 40c serves to expand a temperature detection range of the thermistor 40d and is made of a highly thermally conductive material. In the present embodiment, the heat collecting plate 40c is made of aluminum. A surface of the thermistor 40d is covered with an insulating coating 40e to ensure sliding properties with the inner circumferential surface of the fixing film 20 and electrical insulation. In the present embodiment, the insulating coating 40e is made of a polyimide tape with a thickness of 50 μm. The sponge 40b functions as a heat insulator for the heat collecting plate 40c and the thermistor 40d, and also functions to allow the heat collecting plate 40c and the thermistor 40d to flexibly fit to the fixing film 20. Details of the size and placement of the temperature sensor 40 will be described later.

Next, the fixing film 20 of the present embodiment will be described in detail. The fixing film 20 is formed in a cylindrical shape with a diameter of 10 to 100 mm. In the present embodiment, the fixing film 20 with an outer diameter of 30 mm is used. FIG. 3A is a cross-sectional view showing a region of the fixing film 20 where the conductive layer 20b is present (hereinafter referred to as a heat-generating region), and FIG. 3B is a cross-sectional view showing a region of the fixing film 20 where the conductive layer 20b is not present (hereinafter referred to as a non-heat-generating region). FIG. 3C is a cross-sectional view of the fixing film 20 parallel to the longitudinal direction LD.

As shown in FIG. 3C, the fixing film 20 has heat-generating regions and non-heat-generating regions intermittently present in the longitudinal direction LD. In other words, the fixing film 20 has heat-generating regions and non-heat-generating regions alternately provided in the longitudinal direction LD.

In the heat-generating region, the fixing film 20 has a layer structure including a base layer 20a, the conductive layer 20b, a protective layer 20c, an elastic layer 20d, and a release layer 20e, as shown in FIG. 3A. The base layer 20a, the conductive layer 20b, the protective layer 20c, the elastic layer 20d, and the release layer 20e are stacked in this order in a thickness direction of the fixing film 20, from the inner circumferential surface toward an outer circumferential surface.

A suitable material for the base layer 20a is non-magnetic, has a high volume electrical resistivity, and is excellent in heat resistance. Examples of the material for the base layer 20a include heat-resistant resins represented by polyimide (PI), polyamideimide (PAI), and polyether ether ketone (PEEK), fiber-reinforced resins represented by carbon fiber reinforced plastic (CFRP) and glass fiber reinforced plastic (GFRP), and the like. In a case where heat-resistant resin is used for the base layer 20a, the base layer 20a preferably has a thickness that makes it easy to obtain strength of the fixing film 20, sliding properties of the nip portion Nf, and rotational stability of the fixing film 20. In the present embodiment, the base layer 20a is made of polyimide (PI), and the thickness and uneven shape of the base layer 20a will be described later.

The conductive layer 20b formed on an outer surface of the base layer 20a is preferably made of metal with a low volume electrical resistivity, such as gold, silver, copper, iron, platinum, tin, SUS, titanium, aluminum, or nickel. In the present embodiment, copper, which has a volume electrical resistivity of 1.7×10⁻⁸ Ωm (room temperature), is used for the conductive layer 20b, and the thickness of the conductive layer 20b is 5 μm. Furthermore, as shown in FIG. 3C, the conductive layer 20b is made of a plurality of conductors 20b1 (divided conductors, divided heating elements) each having a ring shape and being electrically divided from each other in the longitudinal direction LD. A forming method and arrangement of the plurality of conductors 20b1 in the present embodiment will be described in detail below.

The protective layer 20c is formed on an outer surface of the conductive layer 20b to protect the conductors 20b1. Similar to the base layer 20a, a suitable material for the protective layer 20c is non-magnetic, has a high volume electrical resistivity, and is excellent in heat resistance. Examples of the material for the protective layer 20c include heat-resistant resins represented by polyimide (PI), polyamideimide (PAI), and polyether ether ketone (PEEK), and fiber-reinforced resins represented by carbon fiber reinforced plastic (CFRP) and glass fiber reinforced plastic (GFRP). A thickness of the protective layer 20c is suitably 20 to 200 μm, which is a thickness that makes it easy to obtain rotational stability of the fixing film 20. In the present embodiment, the protective layer 20c is made of polyimide (PI), and the thickness of the protective layer 20c is 40 μm.

The elastic layer 20d made of a heat-resistant elastic material such as silicone rubber is formed on an outer surface of the protective layer 20c. In the present embodiment, the elastic layer 20d is made of highly thermally conductive silicone rubber and has a thickness of 200 μm.

Furthermore, the release layer 20e is formed on an outer surface of the elastic layer 20d to prevent toner from adhering to the surface (outer circumferential surface) of the fixing film 20 and to prevent occurrence of image defects. A material with excellent non-adhesive properties is suitable for the release layer 20e, and preferred materials include tetrafluoroethylene perfluoroalkyl vinyl ether (PFA), polytetrafluoroethylene (PTFE), tetrafluoroethylene hexafluoropropylene (FEP), tetrafluoroethylene ethylene (ETFE), and the like. In the present embodiment, the release layer 20e is made of PFA and has a thickness of 15 μm.

Meanwhile, the non-heat-generating region of the fixing film 20 has a layer structure including the base layer 20a, the protective layer 20c, the elastic layer 20d, and the release layer 20e, as shown in FIG. 3B. The conductive layer 20b is not present in the non-heat-generating region of the fixing film 20. As described above, the fixing film 20 has heat-generating regions and non-heat-generating regions that are intermittently present in the longitudinal direction LD. Widths of the heat-generating region and the non-heat-generating region vary depending on the material and thickness of a layer configuration of the fixing film 20 in a radial direction (thickness direction), but in the present embodiment, the widths of both the heat-generating region and the non-heat-generating region are 400 μm.

In the present embodiment, the elastic layer 20d is provided between the protective layer 20c and the release layer 20e, but this is not limiting. For example, the elastic layer 20d may be omitted, and the protective layer 20c and the release layer 20e may be adjacent to each other. Furthermore, a primer layer may be provided to strengthen adhesion between the layers.

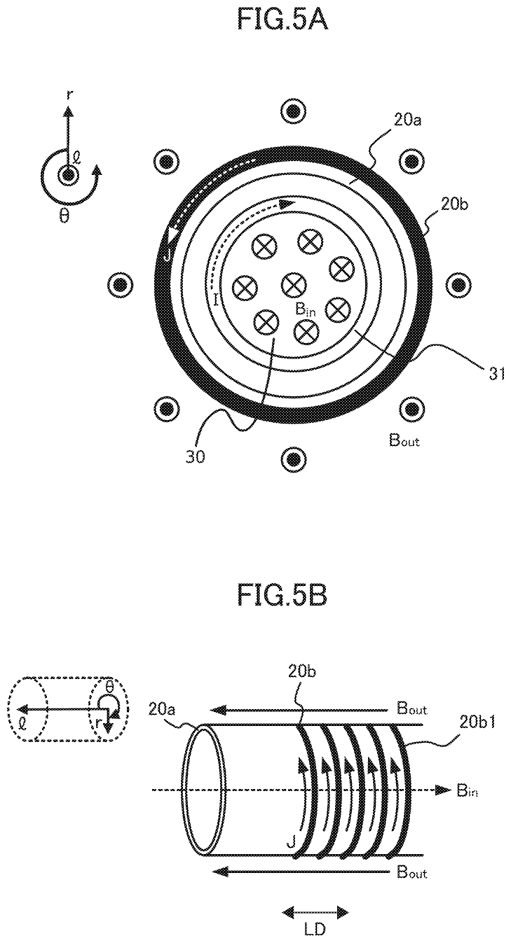

Next, the magnetic core 30 and the excitation coil 31 provided in the internal space of the fixing film 20 will be described. FIG. 4 is a perspective view showing the fixing film 20, the magnetic core 30, and the excitation coil 31. In FIG. 4, directions are shown in a cylindrical coordinate system, with an r-axis representing a radial direction (thickness direction), an l-axis representing an axial direction (longitudinal direction), and a θ-axis representing a circumferential direction (rotation direction). FIGS. 5A to 10 also similarly show directions in a cylindrical coordinate system.

As shown in FIG. 4, the magnetic core 30 has a cylindrical shape extending in the longitudinal direction LD and is disposed substantially at the center of the fixing film 20 by a fixed unit (not shown). This magnetic core 30 functions as a member that guides magnetic field lines (magnetic flux) generated by the alternating magnetic field generated by the excitation coil 31 into the internal space of the fixing film 20 and forms a path (magnetic path) for the magnetic field lines.

The magnetic core 30 is preferably made of a material with low hysteresis loss and high relative permeability. Examples of a preferred material for the magnetic core 30 include a ferromagnetic material made of an oxide or alloy material with high magnetic permeability, such as sintered ferrite, ferrite resin, amorphous alloy, or permalloy. The magnetic core 30 is formed in a shape having an end with a length in the longitudinal direction LD of 200 to 300 mm. It is desirable that the diameter of the magnetic core 30 be as large as possible in terms of cross-sectional area in a range in which the magnetic core 30 can be accommodated inside the fixing film 20. In the present embodiment, sintered ferrite with a length of 240 mm and a diameter of 15 mm is used for the magnetic core 30. The shape of the magnetic core 30 is not limited to a cylindrical shape, and a rectangular prism or the like can be selected.

In the present embodiment, the magnetic core 30 is disposed only within the internal space of the fixing film 20 to form an open magnetic circuit, but this is not limiting. For example, the magnetic core may be disposed outside the fixing film 20 to circulate around the fixing film 20 and form a closed magnetic circuit.

The excitation coil 31 forms a spiral-shaped portion L by winding a single conductive copper wire with a diameter of 1 mm coated with heat-resistant polyamideimide around the magnetic core 30 in a spiral shape around a spiral axis X. The spiral axis X extends substantially parallel to the l-axis and the longitudinal direction LD. In the spiral-shaped portion L, the coils (conductive wires) are spaced evenly apart, and the number of windings is 18. When a high-frequency current (alternating current) is applied to the excitation coil 31 from a high-frequency converter 51 via power supply contacts 31a and 31b, an alternating magnetic field (magnetic field) is generated in the longitudinal direction LD of the fixing film 20.

### Heat Generation Principle of Fixing Film

A heat generation principle of the fixing film 20 will be described with reference to FIGS. 5A and 5B. FIG. 5A shows a cross-section of the fixing film 20 in the longitudinal direction LD, showing a magnetic field and a current flowing through the conductive layer 20b. FIG. 5B is a perspective view showing a magnetic field and a current flowing through the conductive layer 20b. For simplicity, FIGS. 5A and 5B do not show the protective layer 20c, the elastic layer 20d, and the release layer 20e.

FIG. 5A shows an example in which the magnetic core 30, the excitation coil 31, and the conductive layer 20b are disposed concentrically from the center of the fixing film 20. In FIG. 5A, magnetic field lines directed toward the depth of the drawing are represented by Bin (a cross in a circle), and magnetic field lines directed toward the front of the drawing are represented by Bout (a solid dot in a circle).

As shown in FIG. 5A, at the moment when a current in the exciting coil 31 is increasing in the direction of an arrow I, the magnetic field lines Bin directed toward the depth of the drawing are formed in the magnetic path, and the magnetic field lines Bout returning toward the front of the outer side of the fixing film 20 are formed. When these magnetic field lines are formed, an induced electromotive force is applied throughout the entire region of the conductive layer 20b in the circumferential direction to cancel out the magnetic field lines, and a current flows in the direction of an arrow J to circulate around the conductive layer 20b (hereinafter, this current will be referred to as a circulating current).

Since the induced electromotive force is applied in a circulating direction of the conductive layer 20b, the circulating current flows uniformly within the conductive layer 20b. The magnetic field lines generated by the magnetic core 30 are repeatedly generated, eliminated, and reversed in direction due to the high-frequency current flowing through the exciting coil 31, and thus the circulating current flows while being repeatedly generated, eliminated, and reversed in direction in synchronization with the high-frequency current. When a current flows through the conductive layer 20b, Joule heat is generated in the conductive layer 20b due to electrical resistance of the material (metal) of the conductive layer 20b.

Since the magnetic field lines generated by the magnetic core 30 are parallel to the longitudinal direction LD of the fixing film 20, the circulating current flows in the rotation direction of the fixing film 20. Thus, as shown in FIG. 5B, the circulating current flows in the direction of the arrow J in each of the electrically divided conductive layers 20b in the fixing film 20. In this manner, in the fixing film 20 of the present embodiment, applying a high-frequency current to the excitation coil 31 generates an induced current in the divided conductive layers 20b (conductors 20b1), causing the conductive layers 20b (conductors 20b1) to generate heat.

### Fixing Operation

When an image forming operation of the printer 100 is started, the fixing unit 80 described above electromagnetically inductively heats the fixing film 20 using the heat-generating principle described above at a predetermined timing. As shown in FIG. 2A, the fixing unit 80 rotates the pressing roller 22 in the direction of an arrow Rp by rotational driving of a motor (not shown). The fixing film 20 rotates in the direction of an arrow Rf following the rotation of the pressing roller 22, with its inner circumferential surface in contact with the flat surface 21a of the nip portion forming member 21.

As shown in FIG. 4, the high-frequency converter 51 supplies a high-frequency current to the excitation coil 31 via the power supply contacts 31a and 31b. A control circuit 50 controls the high-frequency converter 51 based on a temperature detected by the temperature sensor 40, which is provided at the center of the fixing film 20 in the longitudinal direction LD. Thereby, it is possible to maintain and adjust the surface temperature at a predetermined target temperature (approximately 150 °C to 200 °C) while electromagnetically inductively heating the fixing film 20. As shown in FIG. 2A, the recording material P carrying an unfixed toner image T (image) is nipped and conveyed in the nip portion Nf, whereby heat and pressure are applied to the toner image T, and the toner image T is fixed onto the recording material P.

### Detailed Configuration of Fixing Film

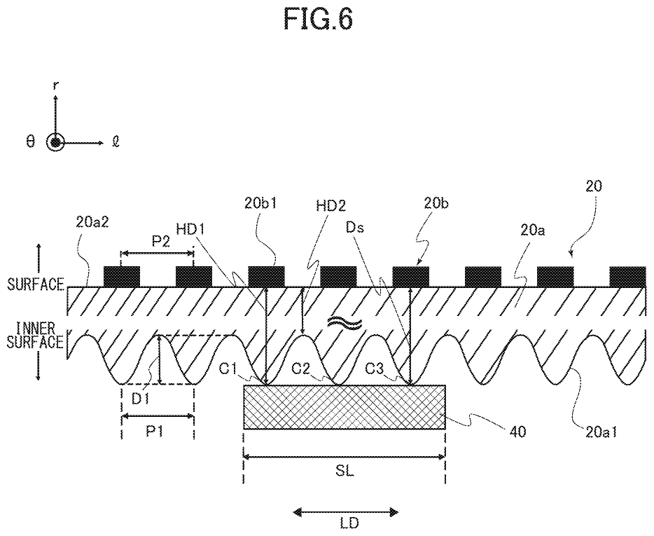

Next, a detailed configuration of the fixing film 20 will be described with reference to FIG. 6. FIG. 6 is a cross-sectional view showing the fixing film 20 at a position where the temperature sensor 40 abuts. FIG. 6 shows a cross-section of the fixing film 20 in the longitudinal direction LD. For simplicity, the protective layer 20c, the elastic layer 20d, and the release layer 20e are not shown.

As shown in FIG. 6, an inner circumferential surface (inner surface) 20al of the base layer 20a of the fixing film 20 is a surface on the rotation center side of the fixing film 20 and has an uneven shape (uneven surface) throughout the entire region in the longitudinal direction LD. The uneven shape of the inner circumferential surface 20al is uniform in the rotation direction (θ-axis direction) of the fixing film 20. For this reason, in a case where the fixing film 20 is cut along a plane along the center of the rotation shaft of the fixing film 20, the fixing film 20 has a cross-sectional shape as shown in FIG. 6 at any position. Although the inner circumferential surface 20al slides against the nip portion forming member 21 when the fixing film 20 rotates, the inner circumferential surface 20al has the uneven shape described above, and thus it is possible to reduce sliding resistance with the nip portion forming member 21.

The inner circumferential surface 20al of the base layer 20a has an uneven shape in which irregularities having a certain shape are arranged alternately, and convex portions adjacent to each other in the longitudinal direction LD are arranged at a pitch (interval) P1 serving as a first pitch. That is, the uneven shape of the inner circumferential surface 20a1 of the base layer 20a has a plurality of concave portions and a plurality of convex portions arranged alternately multiple times in the longitudinal direction LD. The pitch P1 is a distance between the centers of adjacent convex portions in the longitudinal direction LD, that is, a distance between their vertices. In the present embodiment, the pitch P1 is shorter than a width SL of the temperature sensor 40 in the longitudinal direction LD, because the temperature sensor 40 abuts against only the convex portions on the inner circumferential surface 20a1. Thereby, the temperature sensor 40 can stably abut against convex portions C1, C2, and C3 of the base layer 20a.

In the present embodiment, the pitch P1 is 800 μm. Similarly, among the uneven shapes on the inner circumferential surface 20al of the base layer 20a, the concave portions are also arranged at the same pitch as the pitch P1, that is, at intervals of 800 μm. In the present embodiment, adjacent concave portions on the inner circumferential surface 20al of the base layer 20a are periodically provided at a pitch of 800 μm, but this is not limiting, and the pitch does not necessarily have to be periodic.

Next, the shape of the base layer 20a in the thickness direction (r-axis direction, radial direction) will be described in detail. The conductive layer 20b is provided on a surface 20a2 of the base layer 20a. In the present embodiment, the surface 20a2 opposite to the inner circumferential surface 20al is a smooth surface. A thickness from the surface 20a2 to the convex portion (for example, the convex portion C1) of the inner circumferential surface 20al is a thickness HD1. A thickness from the surface 20a2 to the concave portion on the inner circumferential surface 20al is a thickness HD2. That is, a depth (height) from the convex portion to the concave portion is a depth D1, which is a difference between the thickness HD1 and the thickness HD2. The depth D1 is set to a depth such that, when the convex portions on the inner circumferential surface 20al are in contact with the nip portion forming member 21, the concave portions on the inner circumferential surface 20al do not come into contact with the nip portion forming member 21, thereby reducing a contact area between the inner circumferential surface 20al and the nip portion forming member 21. Thereby, it is possible to reduce sliding resistance between the inner circumferential surface 20al and the nip portion forming member 21.

When the depth D1 is excessively large, the thickness HD2 becomes small, making it difficult to obtain sufficient strength and rotational stability of the fixing film 20. For example, when the depth D1 is set to 40 μm or less, it is possible to prevent stress concentration on the concave portion of the fixing film 20, which could lead to breakage of the concave portion. For this reason, the depth D1 is preferably set to 2 to 40 μm, and in the present embodiment, the depth D1 is set to 10 μm.

Next, the pitch in the longitudinal direction LD of the plurality of conductors 20b1 of the conductive layer 20b will be described. A pitch P2 of the conductors 20b1 formed on the surface 20a2 of the base layer 20a is the same as the pitch P1, and is 800 μm in the present embodiment. The pitch P2 serving as a second pitch is a distance between the centers of adjacent conductors 20b1 in the longitudinal direction LD, and the plurality of conductors 20b1 are arranged at the pitch P2. The center position of each conductor 20b1 and the center position of each convex portion formed on the surface 20a2 of the base layer 20a are the same in the longitudinal direction LD. In other words, each convex portion formed on the surface 20a2 of the base layer 20a is disposed such that its position in the longitudinal direction LD is the same as that of any one of the plurality of conductors 20b1. That is, at least one of the plurality of convex portions formed on the surface 20a2 of the base layer 20a contacts the temperature sensor 40 and is positioned at the same location in the longitudinal direction LD as at least one conductor of the plurality of conductors 20b1.

When the pitch P2 of the conductors 20b1 is large, uneven heating is likely to occur on the surface (outer circumferential surface) of the fixing film 20. When uneven heating occurs on the surface of the fixing film 20, gloss of a toner image formed on the recording material P changes, which may result in occurrence of image defects. For this reason, it is preferable to set the pitch P2 of the conductors 20b1 to 1000 μm or less. That is, it is preferable that the pitch P1 be set to 1000 μm or less.

Next, the placement of the temperature sensor 40 will be described. In order to fix the toner image transferred to the recording material P onto the recording material P at an appropriate temperature, the temperature sensor 40 is provided at the center of the fixing film 20 in the longitudinal direction LD, as shown in FIG. 4. That is, the temperature sensor 40 is provided at the center of a sheet passing area of the recording material P, and the width SL of the temperature sensor 40 in the longitudinal direction LD is 2 mm. The temperature sensor 40 abuts against the convex portions C1, C2, and C3 provided on the inner circumferential surface 20al of the base layer 20a. In this manner, it is possible to stably hold the temperature sensor 40 by the plurality of convex portions C1, C2, and C3 abutting against the temperature sensor 40.

Heat generated by the conductor 20b1 is transferred to the base layer 20a, and is transferred from the inner circumferential surface 20al of the base layer 20a to the temperature sensor 40. For this reason, a distance Ds from the conductor 20b1 to the temperature sensor 40 affects responsiveness of the temperature sensor 40 to changes in the temperature of the fixing film 20 (hereinafter simply referred to as responsiveness of the temperature sensor 40). The shorter the distance Ds, the faster the heat is transferred from the conductor 20b1 to the temperature sensor 40, thereby improving the responsiveness of the temperature sensor 40.

In the present embodiment, the position of the convex portion on the inner circumferential surface 20al of the base layer 20a coincides with the position of the conductor 20b1 of the conductive layer 20b in the longitudinal direction LD, and thus the distance Ds from the conductor 20b1 to the temperature sensor 40 is the same for the convex portions C1, C2, and C3. Since the distance Ds is the same as the thickness HD1 of the base layer 20a, and a distance from the conductor 20b1 to the temperature sensor 40 is shortest at the thickness HD1, the responsiveness of the temperature sensor 40 can be improved.

### Comparative Example

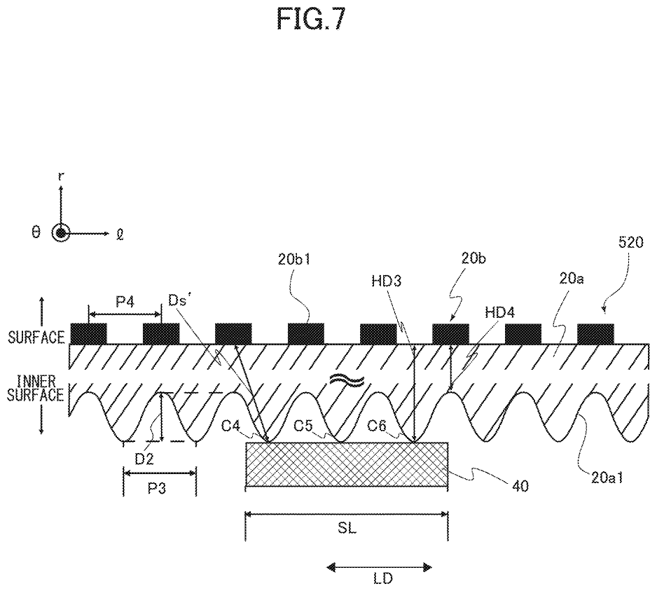

Next, a fixing film 520 according to a comparative example will be described with reference to FIG. 7. FIG. 7 is a cross-sectional view showing the fixing film 520 according to the comparative example. FIG. 7 shows a cross-section of the fixing film 520 in the longitudinal direction LD. For simplicity, the protective layer 20c, the elastic layer 20d, and the release layer 20e are not shown in the drawing. The fixing film 520 has the same layer configuration as the fixing film 20 of the present embodiment, but the placement of the conductor 20b1 differs from that in the present embodiment.

As shown in FIG. 7, the inner circumferential surface 20al of the base layer 20a has an uneven shape similar to that in the present embodiment, and a plurality of convex portions are arranged at a pitch P3. The pitch P3 is the same as the pitch P1 in the present embodiment, and a depth D2 of the convex portion is also the same as the depth D1 in the present embodiment. A thickness from the surface 20a2 to a convex portion (for example, a convex portion C4) of the inner circumferential surface 20al is a thickness HD3, and a thickness from the surface 20a2 to a concave portion on the inner circumferential surface 20al is a thickness HD4. The thicknesses HD3 and HD4 are the same as the thicknesses HD1 and HD2 in the present embodiment, respectively.

In the comparative example, the center position of each conductor 20b1 is the same as the center position of each concave portion formed on the surface 20a2 of the base layer 20a in the longitudinal direction LD. In other words, each concave portion formed on the surface 20a2 of the base layer 20a is positioned at the same location in the longitudinal direction LD as any one conductor of the plurality of conductors 20b1.

In the comparative example, a distance Ds' from the conductor 20b1 to the temperature sensor 40 is longer than the distance Ds in the present embodiment. This is because the position of the conductor 20b1 in the longitudinal direction LD is misaligned with the position of the convex portion (for example, convex portions C4, C5, and C6) of the base layer 20a. The distance Ds' is longer than the thickness HD3 of the base layer 20a. Thus, the responsiveness of the temperature sensor 40 in the comparative example is lower than that in the present embodiment.

In a configuration in which the convex portions on the inner circumferential surface 20al of the base layer 20a of the fixing film 520 and the positions of the conductors 20b1 do not match, as in the comparative example, the distance Ds' is longer than the distance Ds in the present embodiment, and the responsiveness of the temperature sensor 40 is lower than that in the present embodiment. When the responsiveness of the temperature sensor 40 decreases, there is a concern that a delay may occur in temperature control of the conductive layer 20b by the control circuit 50 based on a detection result of the temperature sensor 40, and the temperature of the conductive layer 20b may become higher than a predetermined target temperature.

Here, an example of a method of manufacturing the base layer 20a and a method of manufacturing the conductor 20b1 that enable the positions of the conductors 20b1 in the present embodiment to match the positions of the convex portions on the inner circumferential surface 20al of the base layer 20a in the longitudinal direction LD is briefly described.

In the present embodiment, a method of manufacturing the base layer 20a, which is made of polyimide resin, is described. As the method of manufacturing the base layer 20a, a method is used in which a polyimide precursor solution is cast on the outer side of a cylindrical mold whose surface has an uneven shape with the same pitch as the conductor 20b1, and then the polyimide precursor solution is polymerized to form polyimide resin. Methods of forming an uneven shape on the surface of the mold include embossing, knurling, etching, and the like. As the material for the mold, metal, glass, highly heat-resistant plastic, and the like are used.

Next, an example of a method of manufacturing the conductor 20b1 (conductive layer 20b) will be described. A metal material that forms the above-described conductor 20b1 is electroplated onto the surface 20a2 of the base layer 20a to form the conductive layer 20b. As a method of forming the conductive layer 20b, means such as coating, sputtering, and vapor deposition may be used. Then, an uneven pitch equivalent to the uneven shape of the inner circumferential surface 20al of the base layer 20a is provided on the conductive layer 20b using a technique such as laser etching or chemical etching. Thereby, a plurality of electrically divided conductors 20b1 can be formed on the surface 20a2 of the base layer 20a at the same positions in the longitudinal direction LD as the convex portions on the inner circumferential surface 20al of the base layer 20a.

As described above, according to the present embodiment, the positions of the convex portions on the inner circumferential surface 20al of the base layer 20a of the fixing film 20 are aligned with the conductors 20b1 in the longitudinal direction LD, and thus it is possible to improve the responsiveness of the temperature sensor 40 while reducing sliding resistance between the inner circumferential surface 20al and the nip portion forming member 21.

Another manufacturing method that enables the conductors 20b1 and positions of the convex portions on the inner circumferential surface 20al of the base layer 20a to match in the longitudinal direction LD will now be briefly described. A manufacturing process for the base layer 20a is a known method, and the base layer 20a is made of a heat-resistant resin material such as polyimide resin. The known method is a method including casting a polyimide precursor solution onto a surface of a mold and polymerizing the polyimide precursor solution to form polyimide resin. However, it is not necessary to form an uneven shape in the longitudinal direction LD on the mold as described above at equal intervals with the conductors 20b1.

Next, a method of forming the conductor 20b1 (conductive layer 20b) will be described. A paint containing metal fine particles and a polyimide precursor solution, which are materials for the conductive layer 20b described above, is prepared, and the paint is applied onto the surface 20a2 of the base layer 20a using means such as a blade or screen printing to form a coating film. When applying the paint, divided portions are formed on the surface side of the concave portions of the uneven shape of the inner circumferential surface 20al of the base layer 20a using a method such as masking. By forming the divided portions in the base layer 20a in advance, the conductive layer 20b is electrically divided at predetermined intervals in the longitudinal direction LD. The divided portions are formed at the same pitch as the uneven shape of the inner circumferential surface 20al of the base layer 20a. Thereafter, the coating film is gradually heated and dried to approximately 300 °C to 500 °C to proceed with imidization, thereby firmly adhering to the base layer 20a and forming the plurality of conductors 20b1 electrically divided in the longitudinal direction LD. The subsequent methods of forming the protective layer, the elastic layer, and the surface layer are the same as those used in the manufacturing method described above.

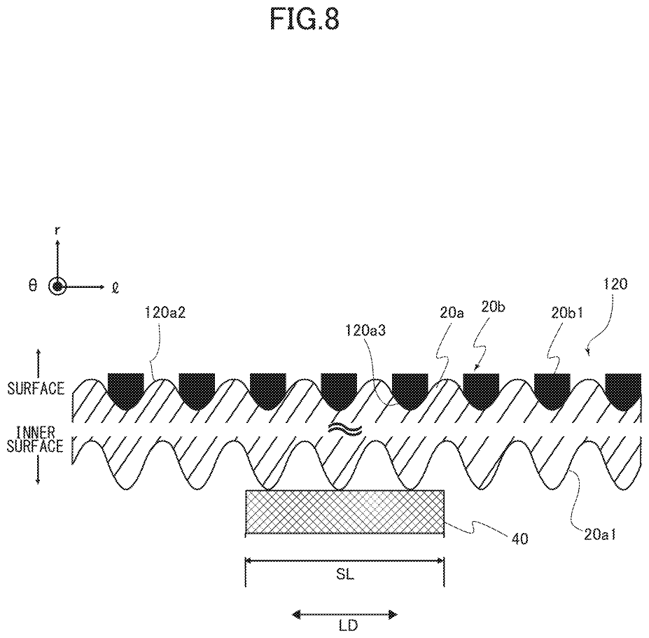

The uneven shape of the inner circumferential surface 20al of the base layer 20a of the fixing film 20 manufactured by this manufacturing method and the position of the conductor 20b1 in the longitudinal direction LD will be briefly described with reference to FIG. 8. FIG. 8 is a cross-sectional view showing a fixing film 120 according to Modification Example 1 at a position where the temperature sensor 40 abuts. FIG. 8 shows the cross section of the fixing film 120 in the longitudinal direction LD. For simplicity, the protective layer 20c, the elastic layer 20d, and the release layer 20e are not shown in the drawing.

As shown in FIG. 8, with the above-described manufacturing method, a surface 120a2 of the base layer 20a also has an uneven shape similar to that of the inner circumferential surface 20al of the base layer 20a. That is, the uneven shape of the surface 120a2 of the base layer 20a has a plurality of concave portions and a plurality of convex portions arranged alternately multiple times in the longitudinal direction LD. The reason for the occurrence of the uneven shape on the surface 120a2 and the inner circumferential surface 20al of the base layer 20a will be described in detail. As described above, the manufacturing method includes gradually heating a paint containing metal particles to approximately 300 °C to 500 °C to form the conductors 20b1. At this time, heat capacity differs between a region where the conductor 20b1 is present (heat-generating region) and a region where the conductor 20b1 is not present (non-heat-generating region) in the longitudinal direction LD. Thus, even when heating is performed at the same ambient temperature, uneven heating occurs between the heat-generating region and the non-heat-generating region, resulting in a difference in the amount of thermal contraction of the base layer 20a. As a result, the base layer 20a is recessed toward its inner surface (inner circumferential surface 20a1) in the heat-generating region where the conductor 20b1 of the base layer 20a is present, while convex portions are formed on the surface of the base layer 20a in the non-heat-generating region. Thereby, a plurality of concave portions 120a3 are formed on the surface 120a2 of the base layer 20a. The uneven shape of the base layer 20a is also formed on the inner circumferential surface 20al of the base layer 20a, forming convex portions on the inner circumferential surface 20al of the base layer 20a in the heat-generating region and concave portions on the inner circumferential surface 20al of the base layer 20a in the non-heat-generating region. This results in a positional relationship between the uneven shapes of the surface 120a2 and the inner circumferential surface 20al of the base layer 20a and the conductors 20b1 as shown in FIG. 8. That is, the plurality of concave portions on the surface 120a2 of the base layer 20a are positioned at the same locations in the longitudinal direction LD as the plurality of convex portions on the inner circumferential surface 20a1.

In this manner, even when an uneven shape is provided not only on the inner circumferential surface 20al of the base layer 20a but also on the surface 120a2 of the base layer 20a, and the positions of the concave portions 120a3 on the surface 120a2 of the base layer 20a, the convex portions on the inner circumferential surface 20a1, and the conductors 20b1 match in the longitudinal direction LD, the same effects as in the present embodiment can be achieved.

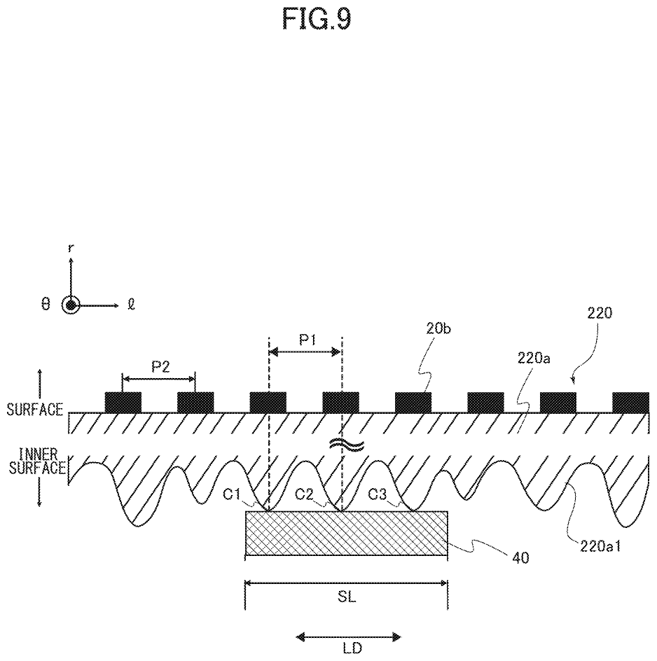

In the present embodiment described with reference to FIG. 6, the convex portions on the inner circumferential surface 20al of the base layer 20a are formed at the pitch P1 over the entire length of the fixing film 20 in the longitudinal direction LD, but this is not limiting. For example, Modification Example 2 of the present embodiment will be described with reference to FIG. 9. FIG. 9 is a cross-sectional view showing a fixing film 220 according to Modification Example 2 at a position where the temperature sensor 40 abuts. FIG. 9 shows the cross-section of the fixing film 220 in the longitudinal direction LD. For simplicity, the protective layer 20c, the elastic layer 20d, and the release layer 20e are not shown in the drawing. The fixing film 220 according to Modification Example 2 has the same configuration as in the present embodiment, except for the shape of an inner circumferential surface 220al of a base layer 220a.

As shown in FIG. 9, the inner circumferential surface 220al of the base layer 220a has an uneven shape, but the pitch and depth of a plurality of convex portions are not uniform. More specifically, the inner circumferential surface 220al of the base layer 220a has a plurality of convex portions C1, C2, and C3 formed thereon to abut against the temperature sensor 40. These convex portions C1, C2, and C3 are arranged at the pitch P1 equal to the pitch P2 of the conductors 20b1. On the other hand, among the plurality of convex portions formed on the inner circumferential surface 220al, those other than the convex portions C1, C2, and C3 do not abut against the temperature sensor 40, and the pitches of these convex portions are not uniform.

In the longitudinal direction LD, the center positions of the plurality of convex portions C1, C2, and C3 that abut against the temperature sensor 40 are the same as the center positions of the conductors 20b1 that correspond to the convex portions C1, C2, and C3. In other words, each of the convex portions C1, C2, and C3 formed on the surface 20a2 of the base layer 20a is positioned at the same location in the longitudinal direction LD as any one conductor of the plurality of conductors 20b1. On the other hand, among the plurality of convex portions formed on the inner circumferential surface 220al, the convex portions other than the convex portions C1, C2, and C3 do not necessarily match the positions of the conductors 20b1 in the longitudinal direction LD.

In this manner, the same effects as in the present embodiment can be achieved simply by making the positions of only the convex portions C1, C2, and C3 that abut against the temperature sensor 40 match the positions of the conductors 20b1.

### Operational Effects of Present Embodiment

Next, an evaluation experiment performed to confirm an effect of improving the responsiveness of the temperature sensor 40 in the present embodiment will be described. To confirm the effect, the fixing film 20 of the present embodiment shown in FIG. 6 and the fixing film 520 according to the comparative example shown in FIG. 7 were used. The distance Ds' from the conductor 20b1 of the fixing film 520 to the temperature sensor 40 is longer than the distance Ds in the present embodiment. The positions of the concave portions on the inner circumferential surface of the base layer 20a of the fixing film 520 shown in FIG. 7 match the positions of the conductors 20b1 in the longitudinal direction LD.

In the evaluation experiment of the present embodiment, a transition of a temperature detected by the temperature sensor 40 was measured when a high-frequency current was applied to the excitation coil 31 to generate Joule heat in the fixing film (20, 520) simultaneously with the driving of the fixing unit 80. Then, a time required for a temperature detected by the temperature sensor 40 to reach 170 °C in the fixing film 20 of the present embodiment was compared with that in the fixing film 520 according to the comparative example.

To heat the fixing film, the high-frequency converter 51 shown in FIG. 4 is controlled to apply an alternating current at a frequency of 80 kHz to the excitation coil 31. The high-frequency converter 51 continues to apply a constant alternating current to the excitation coil 31 until the control circuit 50 detects that the temperature of the temperature sensor 40, which is disposed at the center of the fixing film in the longitudinal direction LD, has reached 170 °C.

Table 1 shows a time required for the temperature sensor 40 to reach 170 °C in each of the present embodiment and the comparative example.

TABLE 1

| | Present Embodiment | Comparative Example |
|---|---|---|
| Reaching time [s] | 9.0 | 9.3 |

In both the present embodiment and the comparative example, the temperature sensor 40 abuts against the convex portions on the inner circumferential surface 20al of the base layer 20a of the fixing film (20, 520), and thus heat from the conductors 20b1 is transferred to the temperature sensor 40 via the convex portions on the inner circumferential surface 20al of the base layer 20a. As described above, in the present embodiment, the distance Ds from the conductor 20b1 to the convex portion on the inner circumferential surface 20al of the base layer 20a is the same as the thickness HD1 of the base layer 20a. On the other hand, in the comparative example, the distance Ds' from the conductor 20b1 to the convex portion on the inner circumferential surface 20al of the base layer 20a is longer than the thickness HD3 of the base layer 20a.

Thus, the distance Ds' from the conductor 20b1 to the convex portion on the inner circumferential surface 20al of the base layer 20a in the comparative example is longer than the distance Ds in the present embodiment. As a result, a time required for the temperature sensor 40 to reach 170 °C was 9.0 s in the present embodiment, while the time was 9.3 s in the comparative example. This indicates that the temperature sensor 40 in the present embodiment was able to detect a temperature 0.3 s faster, improving the responsiveness of the temperature sensor 40.

As such, in the present embodiment, the inner circumferential surface 20al of the base layer 20a is provided with the plurality of convex portions C1, C2, and C3 each of which is positioned at the same location in the longitudinal direction LD as any one conductor of the plurality of conductors 20b1, and thus the responsiveness of the temperature sensor 40 can be improved.

Since the inner circumferential surface 20al has the above-described uneven shape, it is possible to reduce sliding resistance with the nip portion forming member 21, reduce a rotational load on the fixing film 20, and increase a life of the fixing film 20.

In the present embodiment, the effect of the configuration was verified in which the center position of the conductor 20b1 in the longitudinal direction LD matches the center position of the convex portion on the inner circumferential surface 20al of the base layer 20a of the fixing film 20 in the longitudinal direction LD. However, the same effect can be achieved even when the center position of the conductor 20b1 and the center position of the convex portion are slightly misaligned. In the present embodiment, the same effect can be achieved even in a case where the misalignment between the center position of the conductor 20b1 and the center position of the convex portion is 20 μm or less in the longitudinal direction LD. When the misalignment between the center position of the conductor 20b1 and the center position of the convex portion is 20 μm or less, a time required for the temperature sensor 40 to reach 170 °C is 9.0 s as in the present embodiment. In this manner, when the misalignment between the center position of the conductor 20b1 and the center position of the convex portion is 20 μm or less in the longitudinal direction LD, it can be said that the position of the conductor 20b1 and the position of the convex portion abutting against the temperature sensor 40 are the same in the longitudinal direction LD.

### Embodiment 2

Next, Embodiment 2 of the present disclosure will be described. Embodiment 2 differs from Embodiment 1 only in the shape of the film guide 41. For this reason, components similar to those in Embodiment 1 will not be shown in the drawings or will be described with the same reference numerals in the drawings.

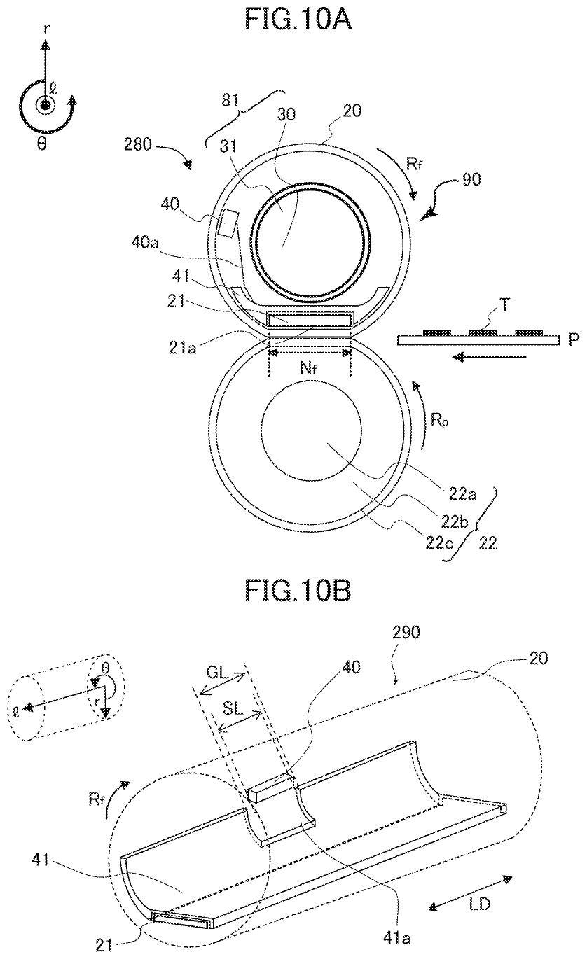

FIG. 10A is a cross-sectional view showing a fixing unit 280 according to Embodiment 2. FIG. 10B is a perspective view showing a heating device 290. FIG. 10B illustrates only the fixing film 20, the nip portion forming member 21, the temperature sensor 40, and the film guide 41 on a downstream side in the direction of the arrow Rf in order to describe a positional relationship between the film guide 41 and the temperature sensor 40 in the longitudinal direction LD.

As shown in FIG. 10A, the fixing unit 280 includes the heating device 290 and the pressing roller 22. As shown in FIG. 10B, also in the present embodiment, the temperature sensor 40 is provided at the center of the fixing film 20 in the longitudinal direction LD as in Embodiment 1. That is, the temperature sensor 40 is located at the center of the sheet passing area of the recording material P, and the width SL of the temperature sensor 40 in the longitudinal direction LD is 2 mm.

The film guide 41 serving as a holding member includes a cut out portion 41a cut out in the direction of the arrow Rf, which is the rotation directional of the fixing film 20, and the cut out portion 41a is formed at the center of the fixing film 20 in the longitudinal direction LD. A width GL of the cut out portion 41a in the longitudinal direction LD is 2 mm or more. In the present embodiment, the width GL is set to 3 mm, and it is undesirable to make the width excessively large in order to obtain sufficient rotational stability of the fixing film 20. For example, the width GL is 10 mm or less. The width GL may also be 5 mm or less.

In the longitudinal direction LD, the cut out portion 41a of the film guide 41 is formed at a position overlapping the temperature sensor 40. That is, in the longitudinal direction LD, the cut out portion 41a is formed on the inner circumferential surface 20al of the base layer 20a of the fixing film 20, and is formed at the same positions as the plurality of convex portions C1, C2, and C3 that abut against the temperature sensor 40. In other words, the cut out portion 41a is provided at positions that corresponds to the plurality of convex portions C1, C2, and C3 in the longitudinal direction LD, and has a width larger than that of a region where the plurality of convex portions C1, C2, and C3 are provided. The region where the plurality of convex portions C1, C2, and C3 contacting the temperature sensor 40 are provided is equal to or smaller than the width SL of the temperature sensor 40.

Here, the region of the fixing film 20 against which the temperature sensor 40 abuts is assumed to be an abutment region, and the region of the fixing film 20 against which the temperature sensor 40 does not abut is assumed to be a non-abutment region. The abutment region includes the plurality of convex portions C1, C2, and C3. The cut out portion 41a of the film guide 41 is formed at a position corresponding to the abutment region in the longitudinal direction LD. At this time, since the cut out portion 41a is formed in the film guide 41, a contact area between the fixing film 20 and the film guide 41 is smaller in the abutment region than in the non-abutment region. As a result, the amount of heat transferred from the inner circumferential surface 20al of the fixing film 20 to the film guide 41 in the abutment region is reduced, allowing the temperature sensor 40 to detect the temperature of the fixing film 20 with high sensitivity. Thereby, it is possible to improve the responsiveness of the temperature sensor 40.

As described above, the cut out portion 41a is provided in the film guide 41 while making the positions of the convex portions on the inner circumferential surface 20al of the base layer 20a match the positions of the conductors 20b1 in the longitudinal direction LD, and thus it is possible to improve the responsiveness of the temperature sensor 40.

### OTHER EMBODIMENTS

In all of the above-described embodiments, three convex portions C1, C2, and C3 that abut against the temperature sensor 40 are formed on the inner circumferential surface 20a1 of the base layer 20a, but this is not limiting. The number of convex portions that abut against the temperature sensor 40 may be two or four or more.

In Embodiment 2, the film guide 41 is provided with the cut out portion 41a, thereby reducing the amount of heat escaping from the fixing film 20 to the film guide 41 and improving the responsiveness of the temperature sensor 40, but this is not limiting. For example, the responsiveness of the temperature sensor 40 may be improved by reducing the heat capacity of another member in contact with the fixing film 20.

In all of the above-described embodiments, a configuration has been described in which the excitation coil 31 inserted into the internal space of the fixing film generates an alternating magnetic field for inductively heating the conductive layer 20b of the fixing film 20. However, this is not limiting, and an excitation coil that generates an alternating magnetic field for inductively heating the conductive layer 20b of the fixing film may also be disposed in an external space of the fixing film. For example, the excitation coil 31 may be disposed above the fixing film 20 in FIGS. 2A and 2B.

Some or all of the above-described embodiments may be combined with each other.

According to the present disclosure, it is possible to improve responsiveness of a temperature sensor to changes in a temperature of a fixing member.

### OTHER EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-082531, filed May 16, 2025, which is hereby incorporated by reference herein in its entirety.

What is claimed is:

1. A heating device configured to heat a toner image borne on a recording material, the heating device comprising:
a fixing member configured to be rotatable and formed in a cylindrical shape; and
a temperature sensor configured to detect a temperature of the fixing member,
wherein the fixing member includes:
a base layer; and
a conductive layer configured to generate heat due to an induced electromotive force when an alternating magnetic field is generated,
the conductive layer includes a plurality of conductors each having a ring shape and being electrically separated from each other in a longitudinal direction of the fixing member,
an inner circumferential surface of the base layer has an uneven shape in which a plurality of concave portions and a plurality of convex portions are alternately arranged multiple times in the longitudinal direction, and
at least one convex portion of the plurality of convex portions is arranged to contact the temperature sensor and is positioned at the same location in the longitudinal direction as at least one conductor of the plurality of conductors.

2. The heating device according to claim 1, wherein the plurality of convex portions are arranged at a first pitch in the longitudinal direction, and
the plurality of conductors are arranged at a second pitch that is the same as the first pitch in the longitudinal direction.

3. The heating device according to claim 2, wherein the first pitch is shorter than a width of the temperature sensor in the longitudinal direction.

4. The heating device according to claim 2, wherein the first pitch is 1000 μm or less.

5. The heating device according to claim 1, wherein a height of each of the plurality of convex portions is 2 to 40 μm.

6. The heating device according to claim 1, wherein a surface of the base layer opposite to the inner circumferential surface is a smooth surface.

7. The heating device according to claim 1, wherein a surface, opposite to the inner circumferential surface, of the base layer has an uneven shape in which a plurality of concave portions and a plurality of convex portions are alternately arranged multiple times in the longitudinal direction, and
the plurality of concave portions on the surface are positioned at the same locations in the longitudinal direction as the plurality of convex portions on the inner circumferential surface.

8. The heating device according to claim 1, further comprising a holding member on which the inner circumferential surface of the base layer slides, the holding member holding the fixing member,
wherein the holding member includes a cut out portion that is cut out in a rotational direction of the fixing member,
the cut out portion is provided at positions in the longitudinal direction corresponding to a plurality of convex portions, among the plurality of convex portions, with which the temperature sensor comes into contact, and
the cut out portion has a larger width in the longitudinal direction than a width of a region in which the plurality of convex portions with which the temperature sensor comes into contact are provided.

9. The heating device according to claim 1, wherein the base layer is made of a resin material.

10. The heating device according to claim 9, wherein the base layer is made of polyimide resin.

11. The heating device according to claim 1, wherein the fixing member is a film.

12. A fixing unit comprising:
the heating device according to claim 1; and
a pressing member configured to be in contact with an outer circumferential surface of the fixing member,
wherein the heating device includes
a magnetic field generation unit configured to form the alternating magnetic field in the longitudinal direction by causing an alternating current to flow therethrough; and
a nip portion forming member disposed in an internal space of the fixing member and on which an inner surface of the fixing member slides; and
the pressing member forms a nip portion which heats a toner image borne on a recording material while sandwiching and conveying the recording material together with the nip portion forming member, with the fixing member sandwiched therebetween.
